(19) United States
(12) Patent Application Publication
(10) Pub. No.: US 2011/0157078 A1
(43) Pub. Date: Jun. 30, 2011

(54) INFORMATION PROCESSING APPARATUS, INFORMATION PROCESSING METHOD, AND PROGRAM

(76) Inventors: Yusuke MIYAZAWA, Tokyo (JP); Fuminori Homma, Tokyo (JP)

(21) Appl. No.: 12/908,820

(22) Filed: Oct. 20, 2010

(30) Foreign Application Priority Data
Dec. 25, 2009 (JP) P2009-295583

(51) Int. Cl. G06F 3/044

(52) U.S. Cl. 345/174

(57) ABSTRACT

An information processing apparatus includes a detection section configured to detect a proximity area of an operating body, and an issue section configured to issue a command for executing a predetermined operation according to a change in the proximity area detected by the detection section. The issue section issues the command when a degree of the change in the proximity area exceeds a predetermined threshold value.

### BACKGROUND OF THE INVENTION

1. Field of the Invention

The present invention relates to an information processing apparatus, an information processing method, and a program, and particularly relates to an information processing apparatus, an information processing method, and a program whereby a predetermined operation is executed according to the degree of change in proximity area of an operating body.

2. Description of the Related Art

One type of a display device is a touchscreen (touch panel) in which a capacitive or resistive touch sensor is provided to the surface of a display section such as a liquid crystal display. With a touchscreen, input to an information processing apparatus is possible by touching a display screen. Thus, a user can handle the information processing apparatus easily.

Further, in recent years, devices have been developed which are capable of not only detecting contact on a display screen but also detecting proximity to the display screen. For example, Japanese Unexamined Patent Application Publication No. 2008-269208 discloses a technique in which a change in capacitance of a palm in proximity to or in contact with a detection surface of a touch panel is detected so as to detect an operation of stroking the detection surface with the palm. Also, for diversity of interactions with a touch panel, it has been desired that a proximity operation in a state where a finger is not in contact be detected.

### SUMMARY OF THE INVENTION

However, when an operation, such as turning of pages, in which a display screen is stroked consecutively with a hand is performed, there has been a problem that identifying the direction of the operation to correctly determine a proximity operation is difficult. Also, in order for a proximity operation and a contact operation to both function, there has been a problem of inconvenience for a user since an operation may involve long movement distance or a long hold of a proximity state in order to prevent a false distinction between the proximity operation and a proximity state before the contact operation.

Thus, it is desirable to provide a novel and improved information processing apparatus, information processing method, and program that are capable of improving the operability of a touch panel by utilizing the degree of change in proximity area.

According to an embodiment of the present invention, there is provided an information processing apparatus including a detection section configured to detect a proximity area of an operating body, and an issue section configured to issue a command for executing a predetermined operation according to a change in the proximity area detected by the detection section. The issue section issues the command when a degree of the change in the proximity area exceeds a predetermined threshold value.

It may be such that the detection section further detects a movement distance of the operating body, and the issue section issues the command when the degree of the change in the proximity area exceeds the predetermined threshold value and the movement distance of the operating body exceeds a predetermined threshold value.

The information processing apparatus may further include a display switch section configured to switch a display of a display screen according to the command issued by the issue section.

It may be such that the issue section issues the command for causing the display switch section to switch the display of the display screen according to a movement direction of the operating body.

It may be such that the issue section issues the command for causing the display switch section to switch the display screen according to the movement direction of the operating body, when the degree of the change in the proximity area exceeds the predetermined threshold value and the movement distance exceeds a predetermined threshold value.

It may be such that the issue section issues the command for causing the display switch section to switch the display screen according to the movement direction of the operating body, when the proximity area decreases below a second area after the proximity area has decreased below a first area and a movement distance of the operating body from a time point at which the proximity area has decreased below the first area to a time point at which the proximity area has decreased below the second area is greater than a predetermined threshold value.

The information processing apparatus may further include an identification section configured to identify the operating body as executing a proximity operation when the proximity area of the operating body detected by the detection section is greater than or equal to a predetermined threshold value. The issue section may issue the command when the operating body is identified as executing the proximity operation by the identification section.

According to another embodiment of the present invention, there is provided an information processing method including the steps of detecting a proximity area of an operating body, and issuing a command for executing a predetermined operation when a degree of a change in the detected proximity area exceeds a predetermined threshold value.

According to still another embodiment of the present invention, there is provided a program for causing a computer to function as an information processing apparatus including a detection section configured to detect a proximity area of an operating body, and an issue section configured to issue a command for executing a predetermined operation according to a change in the proximity area detected by the detection section. The issue section issues the command when a degree of the change in the proximity area exceeds a predetermined threshold value.

According to the embodiments of the present invention described above, the operability of a touch panel can be improved by utilizing the degree of change in proximity area.

### BRIEF DESCRIPTION OF THE DRAWINGS

FIG. 1 illustrates a proximity operation according to an embodiment of the present invention;

FIG. 2 is a block diagram showing the hardware configuration of an information processing apparatus according to the embodiment;

FIG. 3 illustrates a proximity operation and a proximity region of an operating body according to the embodiment;

FIG. 4 illustrates the proximity operation and the proximity region of the operating body according to the embodiment;

FIG. 5 is a block diagram showing the functional configuration of the information processing apparatus according to the embodiment;

FIG. 6A illustrates a contact operation by the operating body according to the embodiment;

FIG. 6B illustrates the proximity operation by the operating body according to the embodiment;

FIG. 7 illustrates a detection of consecutive operations according to the embodiment;

FIG. 8 illustrates the detection of the consecutive operations according to the embodiment;

FIG. 9A illustrates the proximity operation according to a proximity area and a movement amount according to the embodiment;

FIG. 9B illustrates the proximity operation according to the proximity area and the movement amount according to the embodiment;

FIG. 10 illustrates the proximity operation according to the proximity area and the movement amount according to the embodiment;

FIG. 11 is a flowchart showing in detail a determination process of determining the contact operation or the proximity operation according to the embodiment; and

FIG. 12 is a flowchart showing in detail a detection process of the proximity operation according to the embodiment.

### DESCRIPTION OF THE PREFERRED EMBODIMENTS

A preferred embodiment of the present invention will be described in detail below with reference to the accompanying drawings. Note that, in this specification and the drawings, components having substantially the same functional configuration are denoted by the same reference numeral to omit redundant description.

The preferred embodiment of the present invention will be described in the following order.

[1] Purpose of this embodiment
[2] Hardware configuration of information processing apparatus
[3] Functional configuration of information processing apparatus
[4] Operation of information processing apparatus in detail

### [1] Purpose of this Embodiment

First, the purpose of this embodiment is described. One type of a display device is a touchscreen (touch panel) in which a capacitive or resistive touch sensor is provided to the surface of a display section such as a liquid crystal display. With a touchscreen, input to an information processing apparatus is possible by touching a display screen. Thus, a user can handle the information processing apparatus easily.

Further, in recent years, devices have been developed which are capable of not only detecting contact on a display screen but also detecting proximity to the display screen. For example, a technique is disclosed in which a change in capacitance of a palm in proximity to or in contact with a detection surface of a touch panel is detected so as to detect an operation of stroking the detection surface with the palm. Also, for diversity of interactions with a touch panel, it has been desired that a proximity operation in a state where a finger is not in contact be detected.

However, when an operation in which a display screen is stroked consecutively with a hand is performed, there has been a problem that identifying the direction of the operation to correctly determine a proximity operation is difficult. Also, in order for a proximity operation and a contact operation to both function, there has been a problem of inconvenience for a user since an operation may involve long movement distance or a long hold of a proximity state in order to prevent a false distinction between the proximity operation and a proximity state before the contact operation.

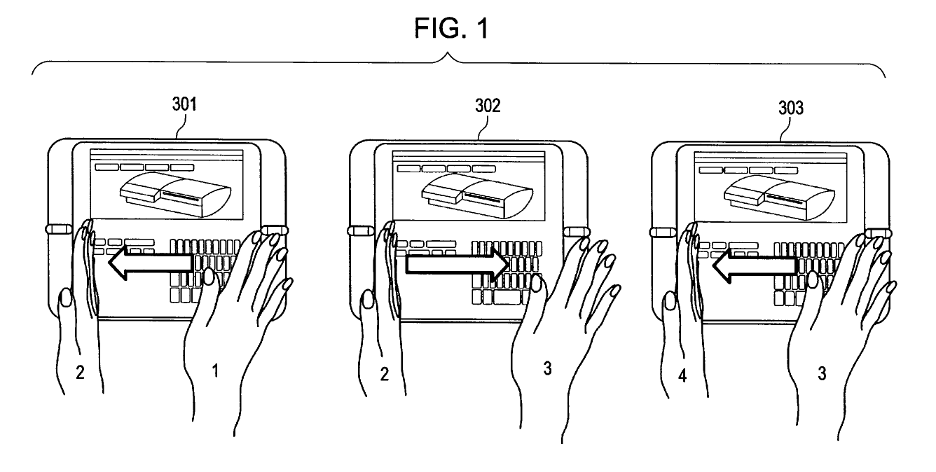

An example of the proximity operation is an operation of turning a page displayed in a display screen with a hand without contact, as shown in FIG. 1. In this case, as shown in an operation example 301, a page-turning operation is performed as if to stroke the display screen from the right side of the display screen to the left direction. When the page-turning operation is to be repeated, the hand located on the left side of the display screen is returned to the right side of the display screen, as shown in an operation example 302, after the operation of the operation example 301. Then, as shown in an operation example 303, the stroking operation above the display screen from the right side of the screen to the left direction is performed again. At this time, it is desirable to distinguish the operation example 301 and the operation example 302 as different operation and to distinguish the proximity operation and the contact operation.

Thus, in consideration of the above circumstance, an information processing apparatus 100 according to the embodiment of the present invention has been created. With the information processing apparatus 100 according to this embodiment, it is possible to improve the operability of a touch panel by utilizing the degree of change in proximity area.

Although a small audio player or media player, a personal digital assistant (PDA), or a mobile phone as shown in FIG. 1 is described as an example in this embodiment, the information processing apparatus 100 is not limited to the example and may be applied to a personal computer or the like. Also, although configured as an integrated apparatus including the display device such as a display, the information processing apparatus 100 is not limited to the example and may be configured as an apparatus separate from the display device.

### [2] Hardware Configuration of Information Processing Apparatus

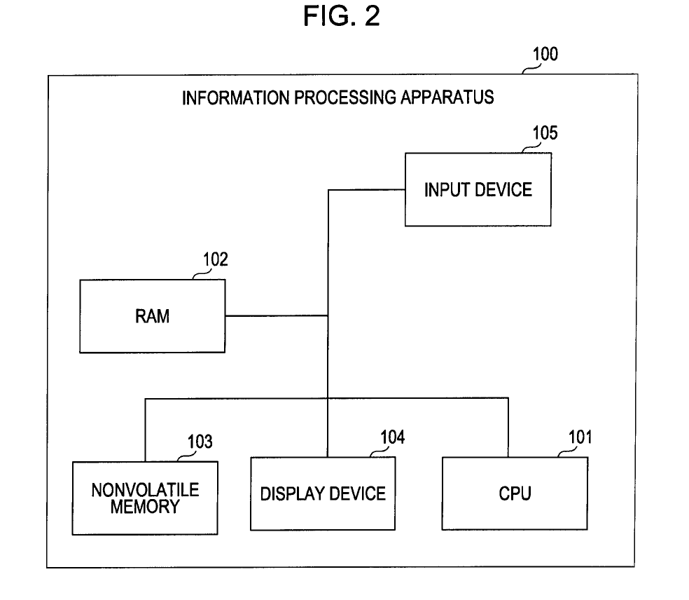

The purpose of this embodiment has been described above. Next, the hardware configuration of the information processing apparatus 100 according to this embodiment is described with reference to FIG. 2. FIG. 2 is a block diagram showing the hardware configuration of the information processing apparatus 100.

The information processing apparatus 100 includes a central processing unit (CPU) 101, a random access memory (RAM) 102, a nonvolatile memory 103, a display device 104, and an input device 105.

The CPU 101 functions as an arithmetic processing unit and a control unit to control operations in general in the information processing apparatus 100 according to various programs. The CPU 101 may be a microprocessor. The RAM 102 primarily stores a program used in an execution by the CPU 101, a parameter that changes in correspondence with the execution, or the like. The nonvolatile memory 103 stores a program, an arithmetic parameter, or the like used by the CPU 101. These are mutually connected by a host bus (not shown) configured of a CPU bus or the like.

The display device 104 is one example of an output device included in the information processing apparatus 100. The display device 104 is configured of, for example, a liquid crystal display (referred below to as LCD) device and outputs a result obtained by various processing performed by the information processing apparatus 100. Specifically, the display device 104 displays the result obtained by the various processing performed by the information processing apparatus 100 as a text or an image.

The input device 105 includes an input mechanism such as, for example, a mouse, a keyboard, a touchscreen, a button, a microphone, a switch, or a lever for the user to input information and an input control circuit that generates an input signal based on an input by the user and outputs the input signal to the CPU 101. The user of the information processing apparatus 100 can input various data or give command for processing operation with respect to the information processing apparatus 100 by operating the input device 105.

In this embodiment, an operation by the user is accepted mainly by detecting an operating body, such as a finger or a hand of the user, using the touch panel. The touch panel provides two functions: display and input. The touch panel according to this embodiment detects whether the finger or hand of the user is in proximity or in contact. When proximity is detected, a region of the proximity is detected. A detection method may involve a resistive system utilizing a metal thin film forming a transparent electrode, a capacitive system in which a position is detected from a change in capacitance between a fingertip and a conductive layer, an infrared ray shielding system, an electromagnetic induction system, or the like, as long as the method enables detection of position information of the operating body with respect to the display.

Herein, a case where the operating body is detected using a capacitive touch panel is specifically described. The capacitive touch panel includes capacitive sensors arranged in a grid pattern. A value of the capacitive sensor changes constantly depending on the change in the capacitance. When the finger as the operating body approaches or contacts the capacitive sensor, the capacitance detected by the capacitive sensor increases. The respective capacitive sensors are capable of acquiring the capacitances simultaneously. It is possible to detect the shape of the finger in proximity or in contact by simultaneous detection of changes in the capacitances in all of the capacitive sensors and interpolation. The capacitive touch panel outputs the value of the detected capacitance to the CPU 101.

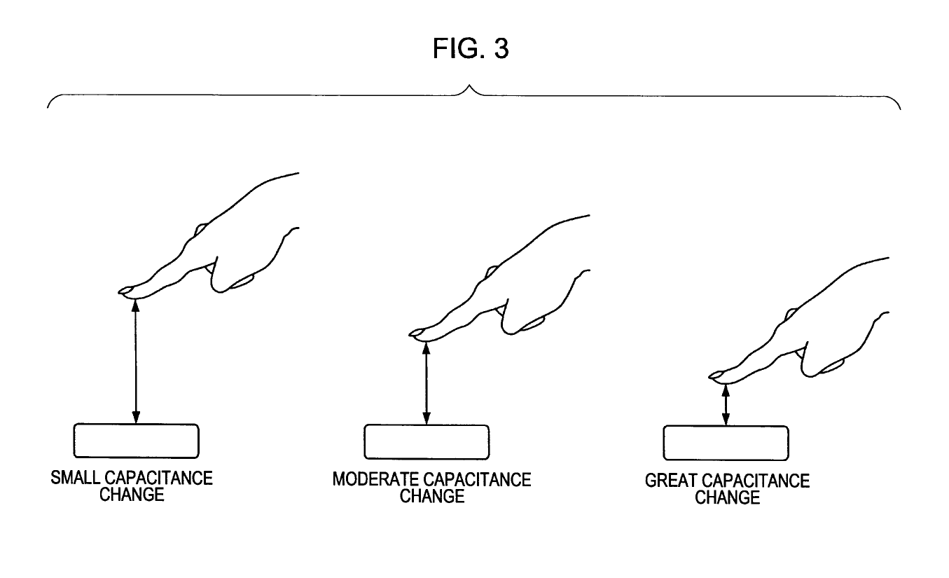

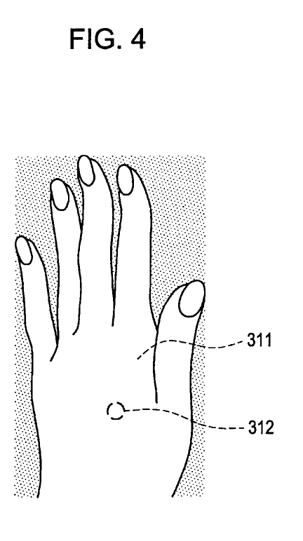

Next, the proximity operation and a proximity region of the operating body according to this embodiment are described with reference to FIGS. 3 and 4. FIGS. 3 and 4 illustrate the proximity operation and the proximity region of the operating body. In this embodiment, the proximity operation refers to an operation of the operating body when the operating body approaches the touch panel and the change in the capacitance of the touch panel is within a predetermined value range. Assume that the change in the capacitance has changed from small to moderate to great, as shown in FIG. 3. When the change in the capacitance is smaller than a predetermined threshold value (the change in the capacitance is small), the operating body is identified as being neither in proximity nor in contact. When the change in the capacitance is greater than a predetermined threshold value (the change in the capacitance is great), the operating body is identified as being in contact. When the change in the capacitance is within the predetermined value range (the change in the capacitance is moderate), the operating body is identified as being in proximity.

Also, as shown in FIG. 4, a proximity detection region 311 refers to a region in which the change in the capacitance of the touch panel is greater than a predetermined value when the operating body is in proximity. The proximity detection region 311 is also referred to below as the proximity area. A center-of-gravity point 312 of the proximity area 311 is calculated to detect the movement of the center-of-gravity point 312 as the movement of the operating body at the time of the proximity operation. By detecting the movement of the center-of-gravity point 312 of the proximity area 311 as the movement of the operating body, it is possible to detect a movement direction or a movement amount (movement distance) of the operating body at the time of the proximity operation.

The hardware configuration of the information processing apparatus 100 according to this embodiment has been described above. Each of the components described above may be configured using a general-purpose member or may be configured of hardware specialized for the function of the component. Thus, it is possible to change the hardware configuration to be utilized, as appropriate, according to the technical level at the time of carrying out each embodiment.

### [3] Functional Configuration of Information Processing Apparatus

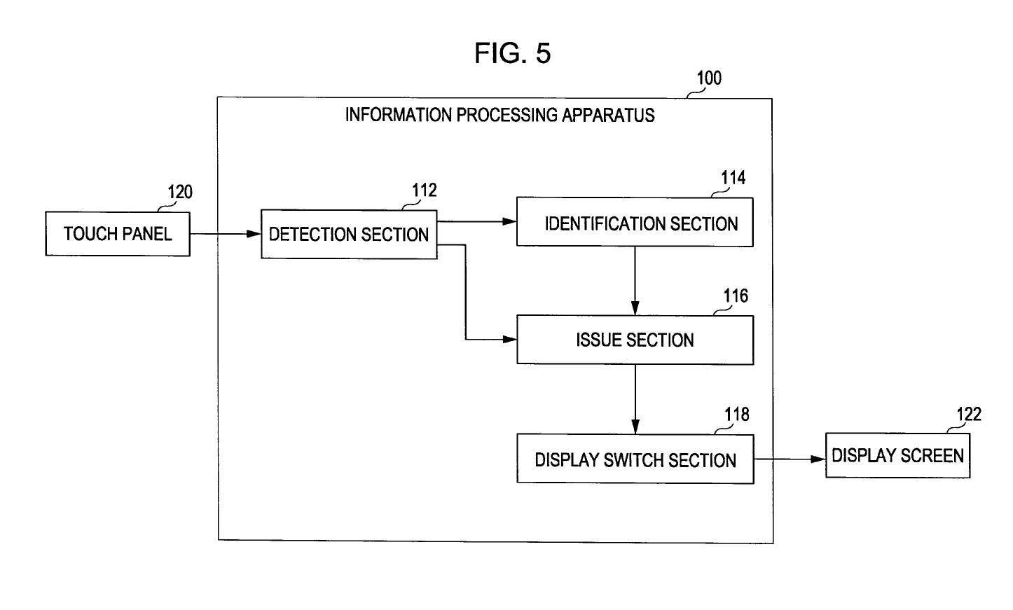

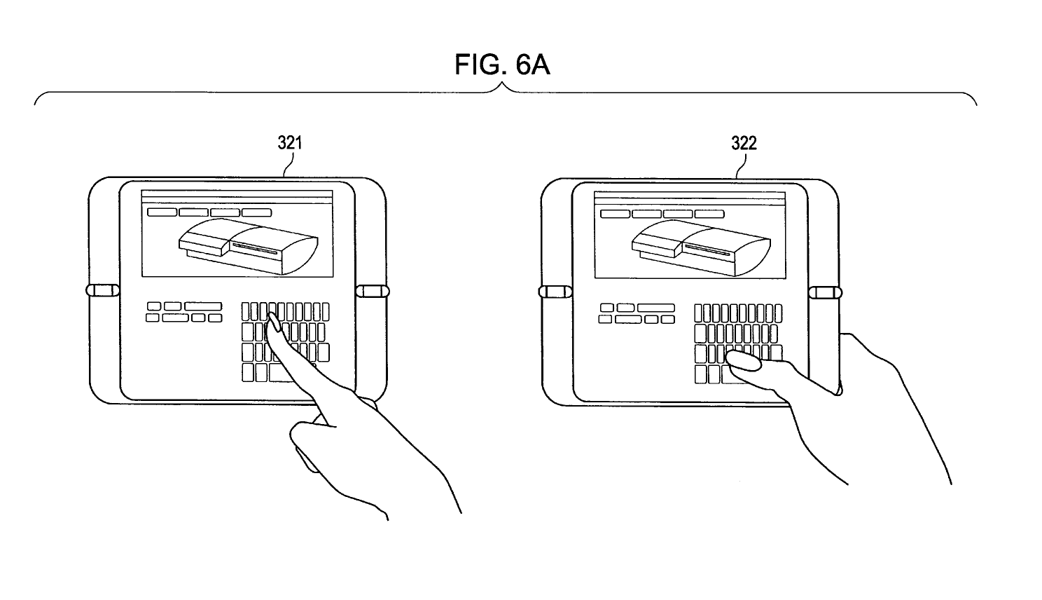

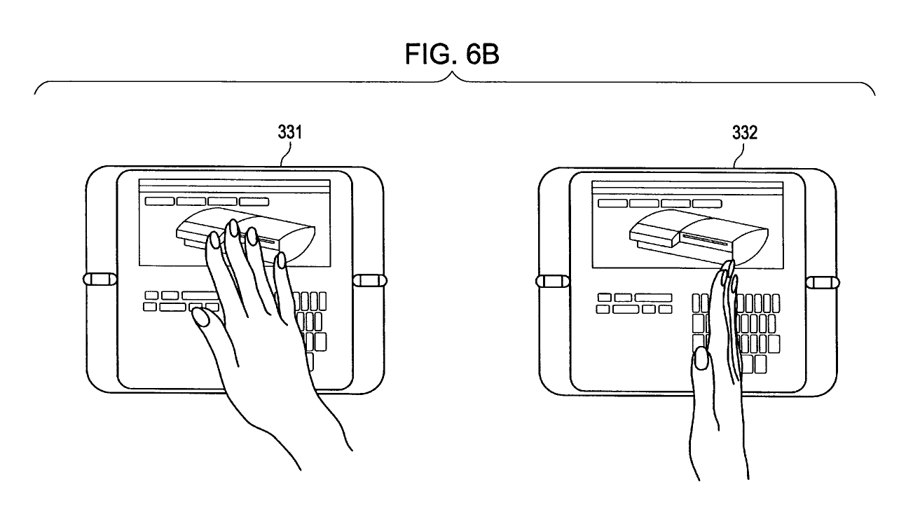

Next, the functional configuration of the information processing apparatus 100 according to this embodiment is described with reference to FIG. 5. With FIG. 5, control in the CPU 101 is described in particular. Note that the functional configuration of the information processing apparatus 100 shown in FIG. 5 is described with reference to FIGS. 6A to 10, as appropriate. FIG. 5 is a block diagram showing the functional configuration of the information processing apparatus 100 according to this embodiment. Note that a display screen 122 is one example of the display device 104 described above, and a touch panel 120 is one example of the input device 105 described above.

As shown in FIG. 5, the information processing apparatus 100 includes a detection section 112, an identification section 114, an issue section 116, and a display switch section 118. The detection section 112 has a function of detecting the proximity area of the operating body. As described above, the capacitance detected by the touch panel 120 increases when the operating body approaches the display screen. When the capacitance detected by the touch panel 120 is greater than the predetermined value, the detection section 112 detects a region in which the change in the capacitance is detected by the touch panel 120 as the proximity area. Also, the detection section 112 has a function of detecting the movement distance of the operating body. The detection section 112 provides the detected movement distance or value of the proximity area to the identification section 114 and the issue section 116.

The identification section 114 has a function of identifying the operating body as executing the proximity operation when the proximity area of the operating body provided by the detection section 112 is greater than or equal to a predetermined threshold value. As described above, when there is a combination of the proximity operation and the contact operation by the operating body, it is desirable to determine whether the operation is the proximity operation or the contact operation at the time of issuing a command described later.

Herein, the contact operation and the proximity operation by the operating body are described with reference to FIGS. 6A and 6B. FIG. 6A illustrates the contact operation by the operating body. FIG. 6B illustrates the proximity operation by the operating body. When the contact operation is performed by the operating body, a selection operation or the like is performed normally with one finger, as shown in FIG. 6A. On the other hand, when the proximity operation is performed by the operating body, the operation is often performed with a palm or the like having great area, as shown in FIG. 6B. That is, in the contact operation, an area greater than the area of one finger is rarely detected.

Thus, when the proximity area detected by the detection section 112 is greater than a certain value, the identification section 114 identifies the operation of the operating body as the proximity operation. An example of the case where the proximity area is greater than the certain value is a case where a region of the display screen in which one or two fingers as the operating body have made contact is stored in advance and the proximity area is greater than the region. Returning to FIG. 5, the identification section 114 provides the result of identification of whether the operation of the operating body is the proximity operation or the contact operation to the issue section 116.

The issue section 116 has a function of issuing the command for executing a predetermined operation according to the change in the proximity area provided by the detection section 112. The issue section 116 stores at predetermined intervals the proximity area provided by the detection section 112 and calculates a change amount of the stored proximity areas. Examples of the predetermined operation include page turning of a page displayed in the display screen, scrolling of the display screen, and enlargement of a display region. The issue section 116 issues the command for executing the operation and provides the command to the display switch section 118.

When not only the proximity area of the operating body but also the movement distance of the operating body is detected by the detection section 112 as described above, it may be such that the command is issued when the degree of the change in the proximity area exceeds a predetermined threshold value and the movement distance of the operating body exceeds a predetermined threshold value. Also, it may be such that the issue section 116 issues a command for switching the display screen according to the movement direction of the operating body.

The display switch section 118 has a function of switching the display of the display screen according to the command issued by the issue section 116. Examples of display switching of the display screen by the display switch section 118 include switching of a page of the display screen and enlargement of the display region, as described above.

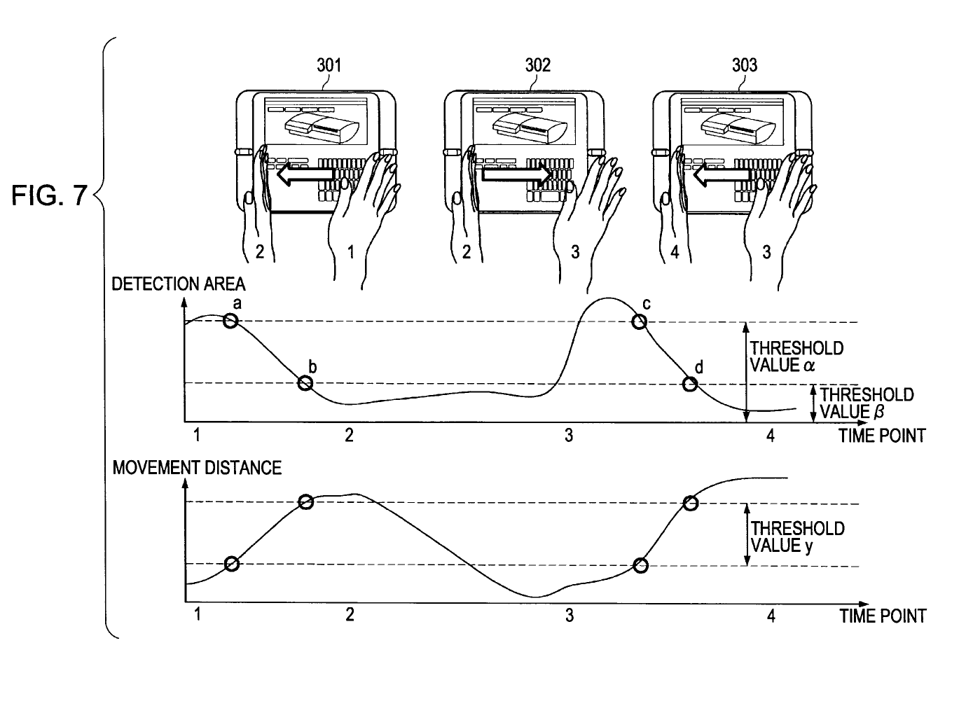

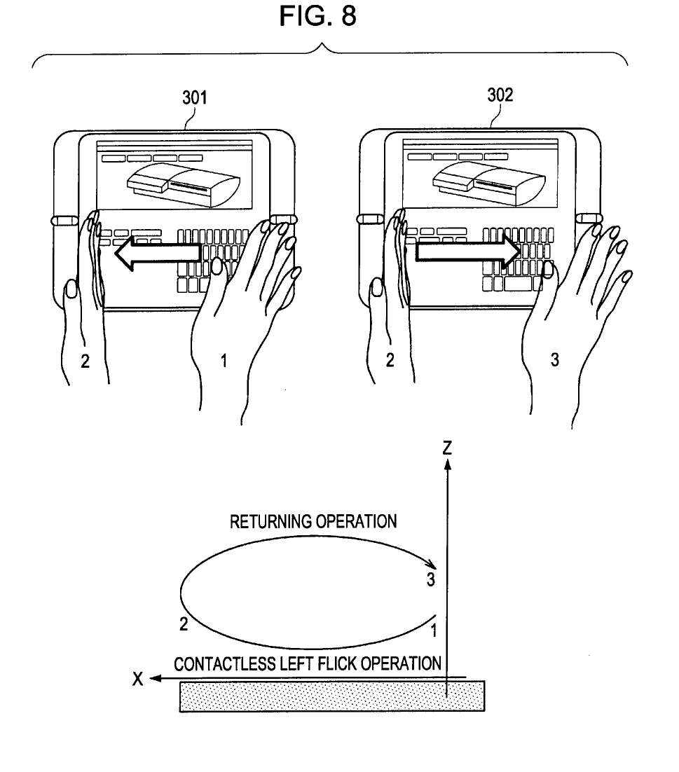

Herein, detection of consecutive operations such as turning of pages is described with reference to FIGS. 7 and 8. FIGS. 7 and 8 illustrate the detection of the consecutive operations. In the operation example 301, the operating body first moves from the right side (1) of the display screen to the left direction (2) as if to stroke the display screen, as shown in FIG. 7. The palm is parallel to the display screen at the start of the operation, but the hand is at an angle nearly perpendicular to the display screen at the end of the operation.

That is, the proximity area is great at the start of the operation, and the proximity area decreases after the start of the operation. Also, the center of gravity of the operating body moves from the right side to the left direction. In this manner, it is possible to recognize the proximity operation by the operating body based on the change in shape and the movement direction of the operating body. Herein, the operation of the operating body moving while reducing the proximity area is referred to as a flick operation, and a flick operation in the proximity operation is particularly referred to as a contactless flick operation. Further, a contactless flick operation from the left to right of the display screen is referred to as a contactless left flick operation, and a contactless flick operation from the right to left of the display screen is referred to as a contactless right flick operation.

In the operation example 302, the page-turning operation of the operation example 301 has ended and the operating body is moved from the left side (2) to the right side (3) of the display screen in order to perform the page-turning operation again. In the operation example 302, the proximity operation by the operating body can be not recognized since the proximity area of the operating body is small.

Herein, the change in the proximity area of the operating body is described with reference to FIG. 8. As shown in FIG. 8 where X direction is a direction parallel to the display screen and Z direction is a direction perpendicular to the display screen, the contactless left flick operation of the operation example 301 is an operation in proximity to the display screen with increased proximity area. At the time of a returning operation in the operation example 302, the proximity area is smaller than that at the time of the contactless left flick operation in the operation example 301 since the distance of the operating body from the display screen increases.

Returning to FIG. 7, when the page-turning operation is to be performed consecutively, the operating body moves from the right side (3) of the display screen to the left direction (4) as if to stroke the display screen to perform the contactless left flick operation again, as shown in the operation example 303. The proximity operation in the operation example 303 is recognized in a similar manner to that in the operation example 301.

Next, the relation between a detection area and the movement distance in the page-turning operation is described with reference to FIG. 7. In FIG. 7, the change in the detection area and the change in the movement distance correspond with the page-turning operation by the operating body. As shown in FIG. 7, the contactless left flick operation performed by the operating body at the time of operation in the operation example 301 causes the proximity area to decrease beyond a threshold value α and to further decrease beyond a threshold value β. The movement distance of the operating body from a time point a at which the proximity area has crossed the threshold value α to a time point b at which the proximity area has crossed the threshold value β is greater than or equal to a threshold value y.

At the time of operation in the operation example 302, the detected proximity area maintains a value smaller than the threshold value β since the operating body moves at a distance from the display screen. Further, in a similar manner to the operation example 301, the contactless left flick operation performed by the operating body at the time of operation in the operation example 303 causes the proximity area to decrease beyond the threshold value α and to further decrease beyond the threshold value β. The movement distance of the operating body from a time point c at which the proximity area has crossed the threshold value α to a time point d at which the proximity area has crossed the threshold value β is greater than or equal to the threshold value y.

Thus, when the proximity area decreases beyond the threshold value β (second area) after the proximity area has decreased beyond the threshold value α (first area) and the movement distance of the operating body from the time point at which the proximity area has decreased beyond the threshold value α to the time point at which the proximity area has decreased beyond the threshold value β is greater than the threshold value y, the issue section 116 issues the command for switching the display screen in the movement direction of the operating body.

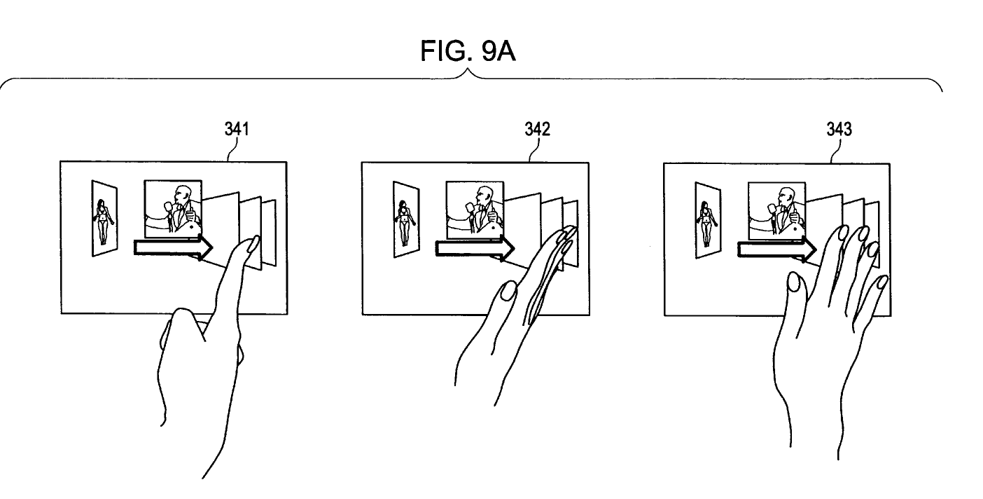

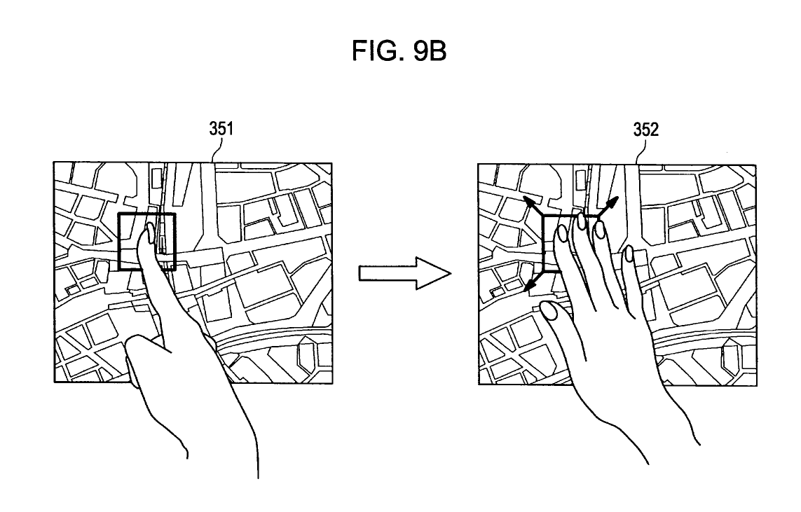

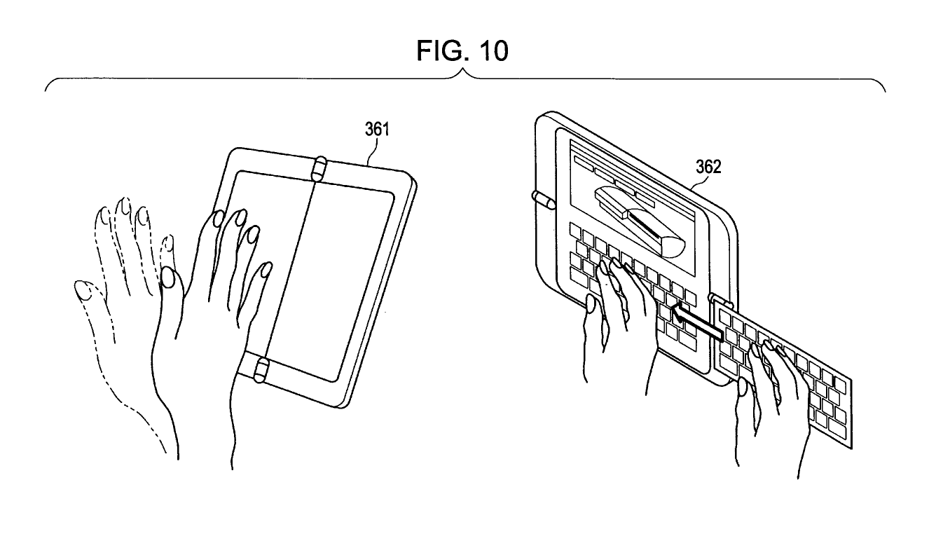

The detection of the consecutive operations such as turning of pages has been described above. Next, other proximity operations according to the proximity area and the movement amount are described with reference to FIGS. 9A, 9B, and 10. FIGS. 9A, 9B, and 10 illustrate the proximity operation according to the proximity area and the movement amount. In FIG. 9A, the operating body performs the contactless right flick operation of moving from the left to right as if to stroke the display screen. In an operation example 341, the contactless right flick operation is performed with one finger. In an operation example 342, the contactless right flick operation is performed in a state where the palm is perpendicular to the display screen. In an operation example 343, the contactless right flick operation is performed in a state where the palm is parallel to the display screen.

As described above, the issue section 116 issues the command for switching the display screen according to the proximity area and the movement amount. For example, it may be such that a threshold value of the proximity area for determining the proximity operation is provided and a command is issued to execute an operation in a stepwise manner. For example, an operation of skipping a track, an operation of skipping an album, and an operation of skipping an artist may be determined by utilizing a first threshold value and a second threshold value in an interface for listening to music.

Specifically, in the operation of the operation example 341, the proximity area of the operating body is identified as being smaller than the first threshold value, and a command is issued to execute the operation of skipping a track. In the operation of the operation example 342, the proximity area of the operating body is identified as being greater than the first threshold value and smaller than the second threshold value, and a command is issued to execute the operation of skipping an album. In the operation example 343, the proximity area of the operating body is identified as being greater than the second threshold value, and a command is issued to execute the operation of skipping an artist. Although the command is issued to execute the operation depending on the amount of the proximity area in the description above, a command may be issued to execute the operation depending on the movement amount of the operating body.

Also, the contact operation and the proximity operation may be consecutive. For example, it may be such that an operation of specifying a region is performed with the contact operation, and then an operation of enlarging the specified region is performed with the proximity operation. As shown in FIG. 9B, the operating body specifies the region with the contact operation (operation example 351) when a map is displayed in the display screen. Then, the operating body enlarges the specified region with the proximity operation (operation example 352). In the operation example 352, the operating body can enlarge the specified region by performing the contactless flick operation in a desired direction.

As described above, the identification section 114 identifies whether the operation of the operating body is the contact operation or the proximity operation. When the identification section 114 identifies the contact operation, a command according to the contact operation is issued. When the identification section 114 identifies the proximity operation, a command according to the proximity operation is issued. In this manner, it is possible to provide a convenient user operation by determining whether the operation of the operating body is the contact operation or the contact operation according to the proximity area in this embodiment.

Applying the information processing apparatus 100 according to this embodiment can improve the operability of the touch panel also when the display screen is divided into two screens, as shown in FIG. 10. For example, as shown in an operation example 361, page turning from display pages displayed in two screens can be performed by performing the contactless flick operation with respect to the display screen. Accordingly, it is possible to switch the display of the display screen with a feel of actually turning a page of a book. Also, chapter skipping, fast-forwarding, or the like of a video display may be executed by performing the contactless flick operation in a similar manner.

Also, the proximity operation may be executed with respect to one screen of the two screens in the divided display screen. For example, as shown in an operation example 362, a keyboard displayed in one screen may be switched by the operating body performing the contactless flick operation. Since the contact operation and the proximity operation can be combined as described above in this embodiment, it is possible to execute selection of a key with the contact operation and execute the switch of the keyboard with the proximity operation.

### [4] Operation of Information Processing Apparatus in Detail

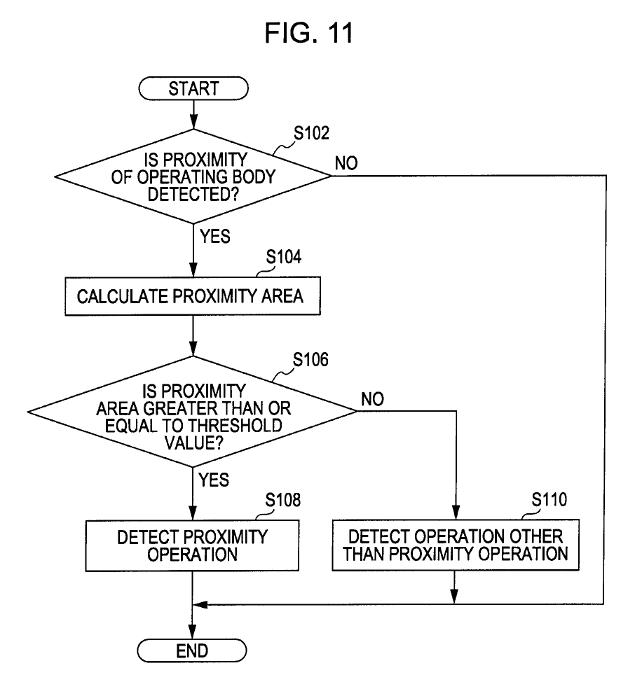

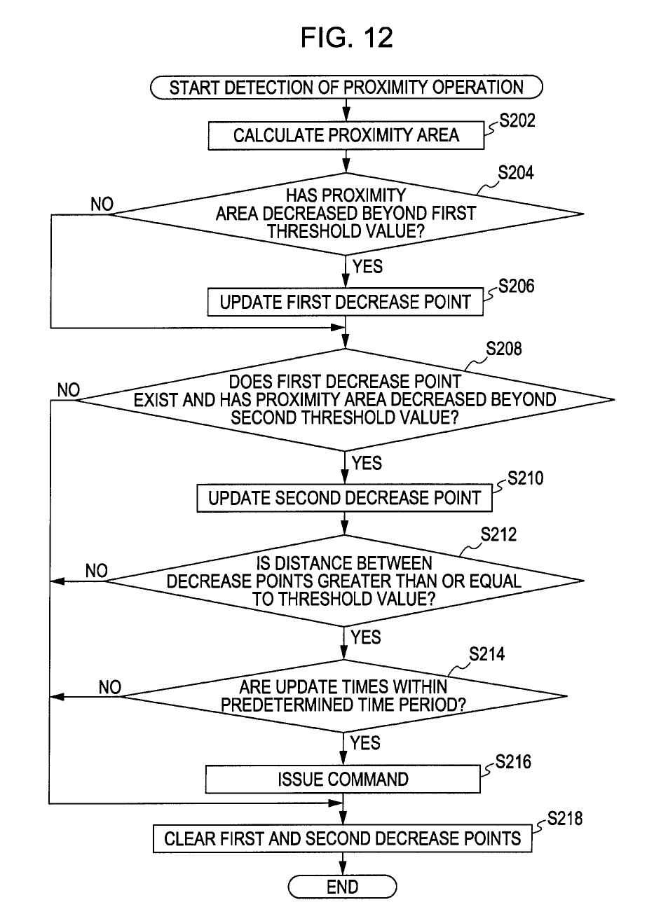

The functional configuration of the information processing apparatus 100 has been described above. Next, the operation of the information processing apparatus 100 is described in detail with reference to FIGS. 11 and 12. FIG. 11 is a flowchart showing in detail a determination process of determining the contact operation or the proximity operation. FIG. 12 is a flowchart showing in detail a detection process of the proximity operation.

As shown in FIG. 11, the detection section 112 first determines whether the proximity of the operating body is detected (S102). As described above, the detection section 112 determines whether the operating body is in proximity from the change in the capacitance detected by the touch panel 120. In step S102, the detection section 112 determines that the operating body is in proximity when an increase in the capacitance is detected. Then, the detection section 112 calculates the value of the proximity area of the operating body (S104). As described above, the detection section 112 detects the region in which the change in the capacitance is detected by the touch panel 120 as the proximity area.

Then, the identification section 114 determines whether the value of the proximity area calculated in step S104 is greater than or equal to a threshold value (S106). For example, an area of the region of the display screen in which one or two fingers as the operating body have made contact is stored in advance. Then, in step S106, the area stored in advance and the proximity area calculated in step S104 are compared.

When it is determined that the proximity area is greater than or equal to the threshold value in step S106, the proximity operation by the operating body is detected (S108). On the other hand, when it is determined that the proximity area is less than or equal to the threshold value in step S106, an operation other than the proximity operation, i.e., the contact operation, is detected as the operation by the operating body (S110).

As described above, when a contact area of one or two fingers as the operating body is stored in advance and the proximity area calculated in step S104 is greater than the area stored in advance, the proximity operation by the operating body is detected. When the proximity area calculated in step S104 is smaller than the area stored in advance, the contact operation by the operating body is detected. The determination process of determining the contact operation or the proximity operation has been described above in detail.

Next, the detection process of the proximity operation in step S108 in FIG. 11 is described with reference to FIG. 12. With FIG. 12, the detection process of the proximity operation of turning a page is described in particular. The proximity operation shown in FIG. 7 is an example of the proximity operation of turning a page described below. That is, the proximity operation of detecting the contactless left flick operation by the operating body to execute the page-turning operation of the display screen is described.

As shown in FIG. 12, the detection section 112 first calculates the proximity area of the operating body (S202). In step S202, the detection section 112 calculates the proximity area of the region in which the change in the capacitance is detected by the touch panel 120, as described above. Then, whether the proximity area has decreased beyond the first threshold value is determined (S204). As shown in FIG. 7, whether the proximity area has decreased beyond the threshold value α (first threshold value) is determined in step S204.

When it is determined that the proximity area has decreased beyond the first threshold value in step S204, a first decrease point is updated (S206). As shown in FIG. 7, the time point at which the proximity area has decreased beyond the threshold value α is stored as the time point a. When it is determined that the proximity area has not decreased beyond the first threshold value in step S204, a process of step S208 is to be executed.

Then, whether the first decrease point exists and the proximity area has decreased beyond a second threshold value is determined (S208). In step S208, the existence of the first decrease point refers to a case where the first decrease point is already stored in a memory such as the nonvolatile memory 103. As shown in FIG. 7, whether the proximity area has decreased beyond the threshold value β (second threshold value) after decreasing beyond the threshold value α is determined.

When it is determined that the first decrease point exists and the proximity area has decreased beyond the second threshold value in step S208, a second decrease point is updated (S210). As shown in FIG. 7, the time point at which the proximity area has decreased beyond the threshold value β is stored as the time point b. When the first decrease point does not exist or when the proximity area has not decreased beyond the second threshold value in step S208, a process of step S218 is executed.

Then, whether a distance between the first decrease point updated in step S206 and the second decrease point updated in step S210 is greater than or equal to a threshold value is determined (S212). The distance between the decrease points refers to a distance between center-of-gravity positions of the operating body detected respectively at the first decrease point and the second decrease point. In step S212, whether the distance between the center-of-gravity position of the operating body at the time point a and the center-of-gravity position of the operating body at the time point b is greater than or equal to the threshold value y is determined, as shown in FIG. 7.

When it is determined that the distance between the decrease points is greater than or equal to the threshold value in step S212, whether time at which the first decrease point is updated and time at which the second decrease point is updated are within a predetermined time period is determined (S214). The proximity area of the operating body executing the contactless flick operation is expected to change within the predetermined time period. Thus, when update times are not within the predetermined time period in step S214, it can be determined that the contactless flick operation is not executed, i.e., the proximity operation is not executed, by the operating body. When a lapse time from the time point a to the time point b is within the predetermined time period in FIG. 7, it can be determined that the operating body has executed the contactless flick operation.

When it is determined that the update times are within the predetermined time period in step S214, the issue section 116 issues the command (S216). In step S216, the issue section 116 issues the command to execute a display switch according to an operation direction of the operating body. For example, when the operating body has executed the contactless left flick operation, the command for moving the display screen from right to left to execute switching of a page or the like is issued.

When the distance between the decrease points is not greater than or equal to the threshold value in step S212 or when the update times are not within the predetermined time period in step S214, the process of step S218 is executed.

After the command is issued in step S216, the first decrease point and the second decrease point are cleared. As shown in FIG. 7, values of the time point a and the time point b are cleared after the command has been issued after the time point b. Then, when the returning operation is executed by the operating body after the time point b and the contactless left flick operation is executed again, the time point c is updated as the first decrease point and the time point d is updated as the second decrease point.

The detection process of the proximity operation has been described above. According to the embodiment described above, the proximity operation according to the change in the proximity area can be executed. Accordingly, types of the proximity operation can be increased to improve the operability in the proximity operation. Also, by detecting each operation after identifying the contact operation or the proximity operation using the proximity area, it is possible for both of the contact operation and the proximity operation to function without false distinction. Accordingly, in the information processing apparatus including the input device such as the touch panel capable of detecting the contact and proximity of the operating body, it is possible to diversify the types of operations without inconvenience for the user to improve the operability.

Although the preferred embodiment of the present invention has been described above in detail with reference to the accompanying drawings, the present invention is not limited to the example. It is clear to those skilled in the art to which the present invention pertains that various modifications or alterations are conceivable within the scope of the technical idea according to the embodiment of the present invention, and it should be understood that they are also naturally within the technical scope of the present invention.

For example, the respective steps in the processing of the information processing apparatus 100 in this specification may or may not be performed chronologically in the order stated in the flowchart. That is, the respective steps in the processing of the information processing apparatus 100 may be different processes or executed in parallel.

Also, it is possible to create a computer program for causing hardware such as the CPU, the ROM, or the RAM built in the information processing apparatus 100 to fulfill a function equivalent to that of each component of the information processing apparatus 100 described above. Also, a storage medium storing the computer program may be provided.

The present application contains subject matter related to that disclosed in Japanese Priority Patent Application JP 2009-295583 filed in the Japan Patent Office on Dec. 25, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a detection section configured to detect a proximity area of an operating body; and
an issue section configured to issue a command for executing a predetermined operation according to a change in the proximity area detected by the detection section;
wherein the issue section issues the command when a degree of the change in the proximity area exceeds a predetermined threshold value.

2. The information processing apparatus according to claim 1, wherein
the detection section further detects a movement distance of the operating body, and
the issue section issues the command when the degree of the change in the proximity area exceeds the predetermined threshold value and the movement distance of the operating body exceeds a predetermined threshold value.

3. The information processing apparatus according to any one of claims 1 and 2, further comprising a display switch section configured to switch a display of a display screen according to the command issued by the issue section.

4. The information processing apparatus according to claim 3, wherein the issue section issues the command for causing the display switch section to switch the display of the display screen according to a movement direction of the operating body.

5. The information processing apparatus according to claim 4, wherein the issue section issues the command for causing the display switch section to switch the display screen according to the movement direction of the operating body, when the degree of the change in the proximity area exceeds the predetermined threshold value and a movement distance exceeds a predetermined threshold value.

6. The information processing apparatus according to claim 5, wherein the issue section issues the command for causing the display switch section to switch the display screen according to the movement direction of the operating body, when the proximity area decreases below a second area after the proximity area has decreased below a first area and a movement distance of the operating body from a time point at which the proximity area has decreased below the first area to a time point at which the proximity area has decreased below the second area is greater than a predetermined threshold value.

7. The information processing apparatus according to any one of claims 1 to 6, further comprising:
an identification section configured to identify the operating body as executing a proximity operation when the proximity area of the operating body detected by the detection section is greater than or equal to a predetermined threshold value;
wherein the issue section issues the command when the operating body is identified as executing the proximity operation by the identification section.

8. An information processing method comprising the steps of:
detecting a proximity area of an operating body; and
issuing a command for executing a predetermined operation when a degree of a change in the detected proximity area exceeds a predetermined threshold value.

9. A program for causing a computer to function as an information processing apparatus comprising:
a detection section configured to detect a proximity area of an operating body; and
an issue section configured to issue a command for executing a predetermined operation according to a change in the proximity area detected by the detection section;
wherein the issue section issues the command when a degree of the change in the proximity area exceeds a predetermined threshold value.
